(19) United States
(12) Patent Application Publication
(10) Pub. No.: US 2004/0111414 A1
(43) Pub. Date: Jun. 10, 2004

(54) System and method for selective execution of statements with surrogate authority

(75) Inventors: Roy James Cornford, San Jose, CA (US); Tom Ulveman Jensen, San Jose, CA (US)

Correspondence Address: Samuel A. Kassatly, 6819 Trinidad Drive, San Jose, CA, 95120, US

(73) Assignee: International Business Machines Corporation, Armonk, NY

(21) Appl. No.: 10/313,729

(22) Filed: Dec. 6, 2002

(51) Int. Cl. G06F 17/30

(52) U.S. Cl. 707/9

(57) ABSTRACT

A selective execution system allows a user to grant a lesser authority to individuals for normal use, but allow them the ability to use a higher level of authority while completing dependent object redefinition. The present system grants the limited ability to recreate dropped objects or views without allowing the user to redefine the object or view. A modification detection code (MDC) is generated for each statement in the tables and dependent views and written to the electronic media. Each party or program along the execution path can read the statement and validate its integrity by regenerating a MDC for the statement and comparing it to the original. If the MDCs match, the statement's integrity is assured and processing can take place accordingly. If the MDCs do not match, alternative processing can take place. Just prior to an statement's execution, the MDC comparison is made to ensure the statement is unaltered and can be processed as desired, such as with the higher authority. If the MDC values do not match or the original MDC value is absent, the statement is deemed altered and can be processed as desired: either the statement will not be executed or it will be executed with the lesser authority.

### FIELD OF THE INVENTION

The present invention generally relates to an authorization mechanism for a database management system. Particularly, this invention provides a user surrogate authorization for the creation of dependent objects when manipulating object definitions, even though the user's authorization does not permit the creation of those objects. More specifically, this invention confers a programmatic surrogate authorization that is verified throughout the creation and monitoring of a modification detection code.

### BACKGROUND OF THE INVENTION

A transfer of operational instructions between diverse parties or applications may require “higher or surrogate authority” during execution of the operations. The integrity of these instructions must be maintained throughout the transfer. Only the original, unaltered instructions are to be executed under the “higher or surrogate” authority. Any altered instructions or introduced instructions should be detected to allow alternative processing to take place, such as to disallow the instruction or execute the instruction with a less-privileged authority.

Users of database management systems, DBMS, require the ability to alter an object or table definition within the database. Altering an object requires the DBMS to unload the data, drop (or delete) the object, create a new object with the changed attribute, and finally to reload the data. When an object is dropped, any object dependent on the object is also dropped or invalidated.

For example, a company uses a database that includes two tables, an employee table that contains general employee information and a payroll table that includes sensitive information such as salary. This table has several attributes, among which are the column names of the table.

The user wishes to update a column name, for example change the name of a column labeled “employee” to “employee number”. Under certain DBMSs, altering the object may require that the object be dropped and then recreated with the new attributes. Dropping the object may cause all dependent objects to also be dropped. When the original object is redefined, these dependent objects must also be redefined.

The user executing the alteration often lacks the authority to recreate some of the dependent objects. Consequently, completing such an alteration requires advanced planning to research the impact and insure that managers or other users with sufficient authority are available during the alteration. Alternatively, a high authority level may be granted temporarily to the user during the alteration. While this temporary authority allows the user to carry out the alteration and redefine the dependent objects, it also gives that user more access to sensitive information or more capability to manipulate the database than the company may desire.

What is therefore needed is a system for programmatically allowing a user surrogate authority to recreate dependent objects, views, and other items during an alteration. The need for such a system and associated method has heretofore remained unsatisfied.

### SUMMARY OF THE INVENTION

The present invention satisfies this need, and presents a system, a computer program product, and associated method (collectively referred to herein as “the system” or “the present system”) for selective execution of statements or instructions with surrogate authority. The present system allows a user to grant a desired or lesser authority to individuals for normal use, but allows them the ability to use a surrogate or higher level of authority when appropriate as determined by the system.

It is one feature of the present system to provide a mechanism whereby the user may be granted the limited ability to recreate dropped objects or views without allowing the user to redefine the object or view. Though the present system is described in terms of a database management system, DBMS, it can also be applied to security measures or applications.

According to one embodiment of the present invention, each of the operational instructions is assigned a “modification detection code” (MDC). Each party or application along the execution path can read the instruction and validate its integrity by regenerating a MDC for the instruction and comparing the regenerated MDC to the original MDC. If these two MDCs match, the instruction's integrity is assured and processing can take place accordingly. If, however, the two MDCs do not match, alternative processing can take place.

The MDC comparison is made prior to an instruction's execution, to ensure that the instruction is unaltered and that it can be processed as desired, such as with a higher authority. If the MDC values do not match or the original MDC value is absent, the instruction is deemed altered and can be processed as desired: either the instruction will not be executed, or it will be executed with lesser authority.

The present system secures statements for higher authority execution. It also meets a customer's need to modify the statements if necessary, so long as execution of that statement is within their normal authority. Customers can deploy lower authority levels to allow a user to maintain the objects within their normal job scope, yet acquire higher authority programmatically to restore objects affected by their job duties.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a system for the selective execution of statements or instructions with surrogate authority can be used according to the present invention;

FIG. 2 is a block diagram of a high-level overview of a method of operation of the selective execution system of FIG. 1; and

FIG. 3 is comprised of FIGS. 3A and 3B, and represents a process flow chart further illustrating the method of operation of FIG. 2, for the selective execution system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

DDL (Data Definition Language): A language used to define data and their relationships to other data. It is used to create the data structure in a database.

Modification Detection Code: A fixed-size output converted from a variable-sized amount of text by a hash function. Hash functions are used in creating digital signatures and other security measures.

Object: In object-oriented design or programming, a data item with instructions for the operations to be performed on it.

Surrogate authority level: A third party authority level, or an authority level that is different from the user's authority level.

Statement: A text that includes, for example, an instruction, but is not limited thereto.

View: In database management systems, a view is a particular way of looking at data. A single database can support many different views. Typically, a view arranges the records in some order and makes only certain fields visible. Views do not affect the physical organization of the database.

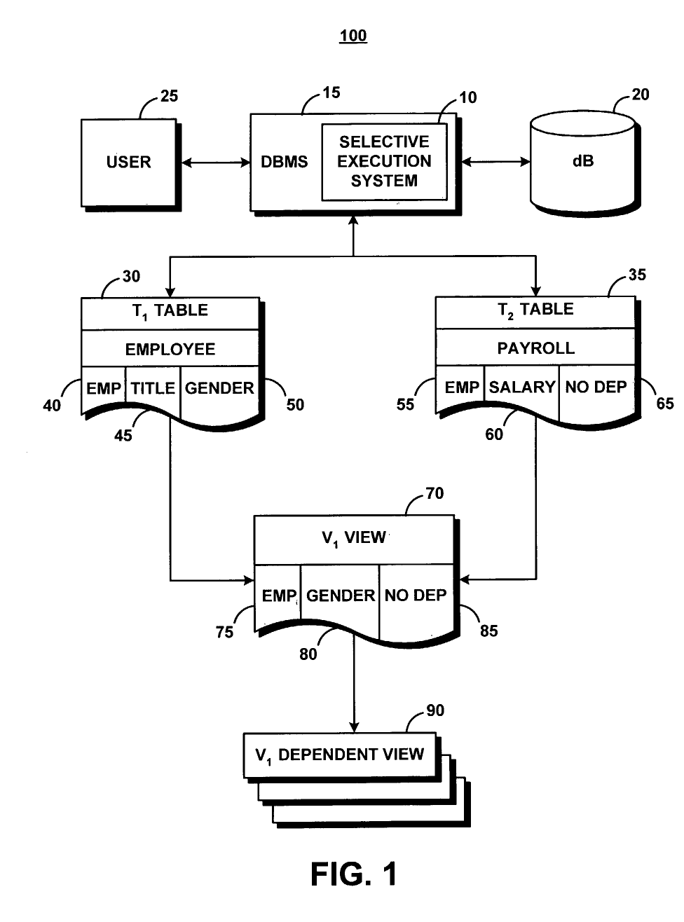

FIG. 1 illustrates an exemplary high-level architecture of an environment in which a system 10 that utilizes a method for a selective execution of statements or instructions with surrogate authority may be used. The selective execution system 10 includes a software programming code or computer program product that is typically embedded within, or installed on a computer. Alternatively, system 10 can be saved on a suitable storage medium such as a diskette, a CD, a hard drive, or like devices. While system 10 is described in the context of a database management system (DBMS) for illustrative purposes, it can be extended to security measures or applications.

In the exemplary illustration of FIG. 1, system 10 is installed in a DBMS 15. DBMS 15 stores data in a database 20. A user 25 accesses the DBMS 15 for use and maintenance. DBMS 15 contains objects such as table TI, 30, and table T2, 35, presented here as illustration only. Table T1, 30, is labeled the employee table; and Table T2, 35, is labeled the payroll table. Table T1, 30, contains attributes such as columns EMP 40, TITLE 45, and GENDER 50. Table T2, 35, contains columns EMP 55, SALARY 60, and NODEP 65.

Table T1, 30, and Table T2, 35, are joined through View V1, 70. View V1, 70, contains columns EMP 75, GENDER 80, and NODEP 85. In this simplified DBMS example, columns EMP 40, EMP 55, and EMP 75 are identical; columns GENDER 50 and GENDER 80 are identical; and columns NODEP 65 and NODEP 85 are identical. A join of two tables creates a logical table called a View V1. A view is a window into multiple objects. Additional dependent views, such as View V2, 90, can be created as part of the DBMS 15 structure. In this example, View V2, 90, is dependent on View V1, 70.

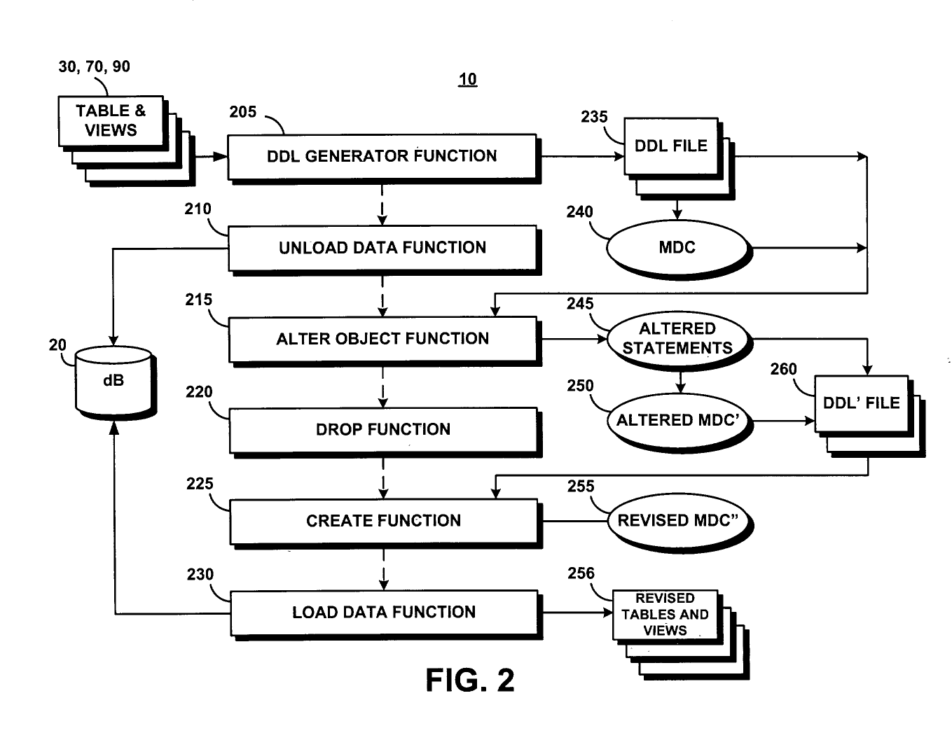

FIG. 2 illustrates a high-level hierarchy of system 10 and its method of operation. The dashed arrow lines in FIG. 2 indicate a temporal relationship, while the solid arrow lines represent the flow of data.

The operation of system 10 requires six functions: a DDL generation function 205, an unload data function 210, an alter object function 215, a drop function 220, a create function 225, and a load data function 230. Using the DBMS example of FIG. 1, the user 25 wishes to change the column title of EMP 40 to “EMP NO”, representing a change from the title “employee” to “employee number”.

Starting with the DDL generation function 205, it takes Table T1, 30, along with all the objects in the dependency chain, and creates statements in a data definition language (DDL) file such as DDL file 235. These statements define the objects and other attributes for Table T1, 30; View V1, 70; and the dependent views as represented by View V2, 90.

Within the DDL file 235 is all the information required to reconstruct the environment affected by a change in the EMP 40 column title. In addition to creating the DDL file 235, the DDL generation function 205 creates a modification detection code (MDC) 240 for each statement in the DDL file 235. The MDC 240 could be stored in the DDL file 235. This feature of system 10 is used to detect any modification to the statements of the DDL file 235.

The unload data function 210 unloads the data from Table T1, 30, and stores it in a file in database 20. Known or available application could be used to implement the unload data function 210.

The alter object function 215 receives the DDL file 235 and modifies each statement therein to include the new attributes (such as “EMP NO”) that have been added by a database administrator, for creating the altered statements 245. In addition, the alter object function 215 creates an altered MDC, such as derived MDC′ 250, for each statement in the DDL file 235, and creates an altered DDL file, DDL′, 260.

The DDL file 235, the altered statements 245, and the derived MDC′ 250 are combined by the alter object function 215 into the altered DDL′ file 260. In the present example, the alter object function 215 changes EMP 40.

The drop function 220 deletes the altered objects from the DBMS 15 structure. In this example, the drop function 220 deletes Table T1, 30 and all dependent objects from the DBMS 15. Known or available application could be used to implement the drop function 220.

The create function 225 receives the altered DDL′ file 260 and automatically executes each statement of the altered statements 245 contained in the altered DDL′ file 260. The create function 225 redefines the data structure set (i.e., the environment) using the new (or user-revised) attributes. The create function 225 further restores the dependency chains in the DDL file 235 and the DDL′ files 260, to create table T1 including the dependent objects. At this stage, the Table is not populated.

The create function 225 derives a revised MDC″ 255, and compares the derived MDC′ 250 with the revised MDC″ 255 to determine which authority to use when executing the statements, i.e., the authority of user 25 or a surrogate level authority. The create function 225 then executes the statements in the DDL′ file 260 to redefine the environment or data structure set using the new attributes. As described earlier, restoring the dependency chains at this stage recreates the views as well, but without the data.

A feature of the present system 10 is the ability of the create function 225 to restore the dependency chains as defined in the original DDL file 235 and the altered DDL′ file 260.

The load data function 230 then reloads the data from the database 20 to the reconstructed Table T1, 30, and the various views in the dependency chain. Known or available applications could be used to implement the load data function 213.

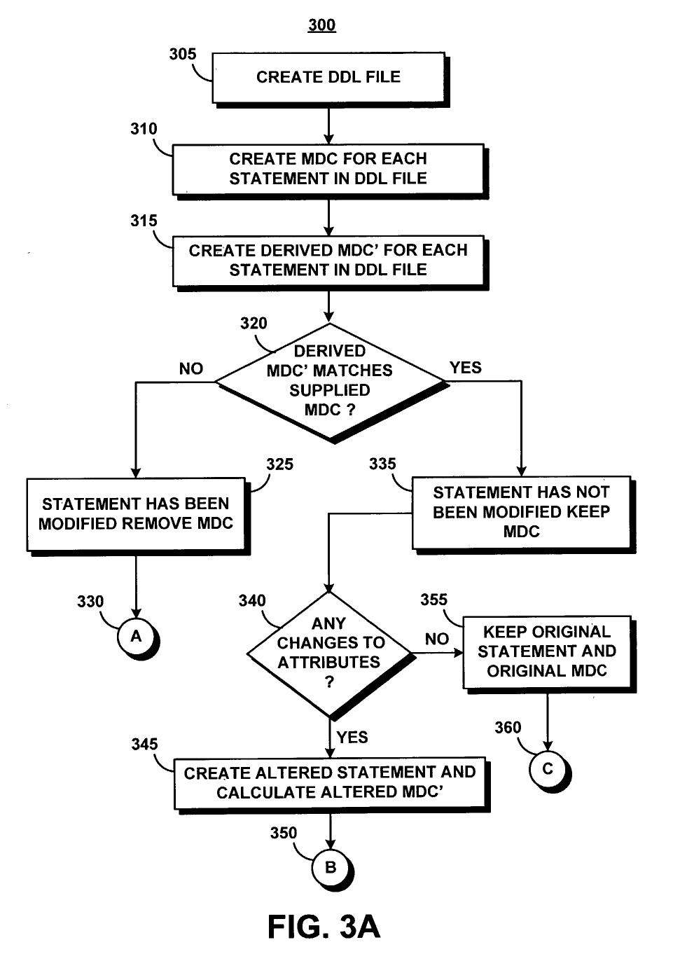

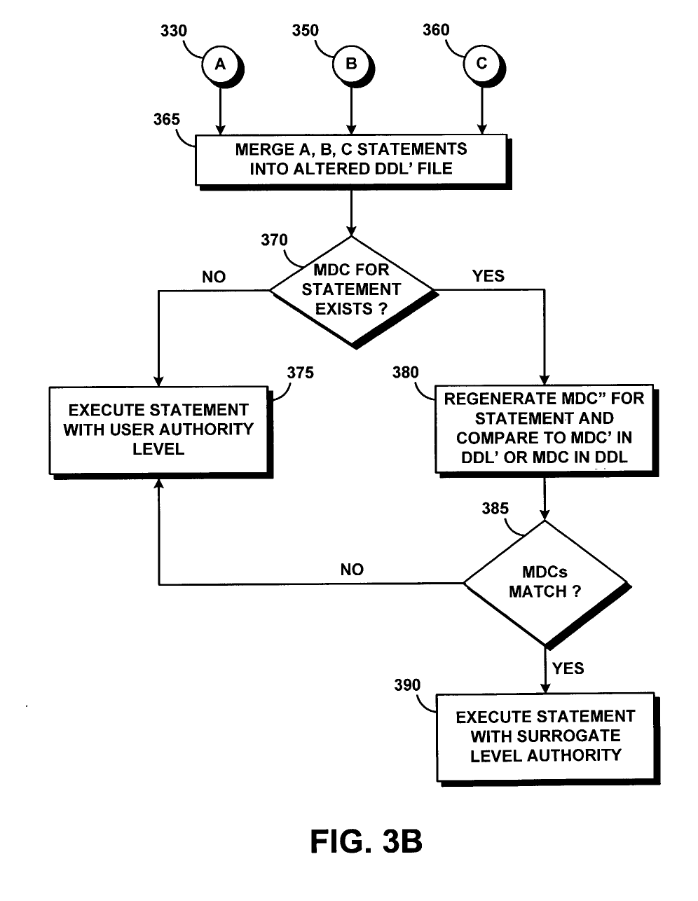

The process flow chart of FIGS. 3A and 3B (FIG. 3) illustrates a method of operation 300 of system 10. Method 300 will now be described with further reference to FIG. 2. At block 305 of FIG. 3A, the DDL generation function 205 creates the DDL file 235 from the structure of DBMS 15 and the dependency chains for the object being altered. The DDL generation function 205 then creates the MDC 240 for each statement in the DDL file 235 (block 310).

At block 315, the alter object function 215 creates a derived MDC′ 250 for each statement in the DDL file 235. At decision block 320 and for each statement, the alter object function 215 compares the derived MDC′ 250 with the original MDC 240. If the original MDC 240 and the derived MDC′ 250 do not match, system 10 proceeds to block 325, and notes that the statement has been modified. The alter object function 215 then removes the original MDC 240 and the derived MDC′ 250. Block A 330 contains the modified statement with no MDC.

If system 10 determines at block 320 that the original MDC 240 and the derived MDC′ 250 match, system 10 proceeds to block 335 and notes that the statement has not been modified. The alter object function 215 keeps the original MDC 240, and proceeds to decision block 340.

At decision block 340, the alter object function 215 determines if any changes have been made to the attributes of the statement. If a change has been made, the alter object function 215 revises the statement and creates an altered statement 245 at block 345. The alter object function further calculates a corresponding derived MDC′ 250 for the altered statement 245. Block B 350 contains the altered statement 245 and the derived MDC′ 250.

If, however, system 10 determines at decision block 340 that no attribute changes are found, the alter object function 215 retains the original statement and the original MDC 240 at block 355. Block C 360 contains the original statement and the original MDC 240.

When all the statements in the original DDL file 235 (FIG. 2) have been analyzed pursuant to steps 305-360 of method 300, as described earlier, the alter object function 215 merges, at block 365, the statements and the corresponding MDCs in blocks A 330, B 350, and C 360, to create the altered DDL′ file 260.

For each statement in the altered DDL′ file 260, the create function 225 considers each of the statements in blocks block A 330, block B 350, and block C 360, and for each statement it determines, at decision block 370, whether that statement has a corresponding MDC, whether an original MDC 240 or a derived MDC′ 250. If not, the create function 255 proceeds to block 375 and executes the statement with the authority level of user 25.

If, however, the create function 225 determines at decision block 370 that an original MDC 240 or a derived MDC′ 250 does exist for the statement in consideration, the create function 225 proceeds to block 380. At block 380, the create function 225 regenerates a revised MDC″ 255 for the statement, and compares the MDC″ 255 to either the original MDC 240 or the derived MDC′ 250 for the statement, as the case may be.

If the regenerated or revised MDC″ 260 matches the original MDC 240 or the altered DDL′ 250, the create function 225 executes the statement with a surrogate level authority at block 390. Otherwise, the create function 215 proceeds to block 375 and executes the statement with the user's authority level.

It is to be understood that the specific embodiments of the invention that have been described are merely illustrative of certain applications of the principle of the present invention. Numerous modifications may be made to the method for selective execution of statements or instructions with surrogate authority invention described herein without departing from the spirit and scope of the present invention. It is to be understood that while the present invention is described in terms of a database management system, it can also be applied to other optimization management techniques such as security measures.

What is claimed is:

1. A method for selectively executing statements with a surrogate authority, comprising:
generating a modification detection code for each statement;
checking the integrity of the modification detection code;
if the integrity of the modification detection code is validated, executing the statement with the surrogate authority; and
if the integrity of the integrity of the modification detection code is not validated, executing the statement with a lesser authority.

2. The method of claim 1, further comprising a file that contains the statements.

3. The method of claim 2, wherein checking the integrity of the modification detection code comprises generating a derived modification detection code from a presented modification detection code, for each statement, and comparing the derived modification detection code to the presented modification detection code.

4. The method of claim 3, wherein the integrity of the modification detection code is validated if the derived modification detection code matches the presented modification detection code.

5. The method of claim 3, wherein the integrity of the modification detection code is not validated if the derived modification detection code does not match the presented modification detection code.

6. The method of claim 3, wherein the integrity of the modification detection code is not validated if no modification detection code exists.

7. The method of claim 2, further comprising unloading data to a database.

8. The method of claim 3, further comprising modifying the statements with new attributes for creating altered statements.

9. The method of claim 8, further comprising generating a revised modification detection code for each statement.

10. The method of claim 9, further comprising comparing the revised modification detection code to the derived modification detection code, to validate the integrity of the derived modification detection code, for determining an authority for execution of the statement.

11. A computer program product having instruction codes for selectively executing statements with a surrogate authority, comprising:
a first set of instruction codes for generating a modification detection code for each statement;
a second set of instruction codes for checking the integrity of the modification detection code;
if the integrity of the modification detection code is validated, the second set of instruction codes executes the statement with the surrogate authority; and
if the integrity of the integrity of the modification detection code is not validated, the second set of instruction codes executes the statement with a lesser authority.

12. The computer program product of claim 11, further comprising a DDL generation function that defines a file that contains the statements.

13. The computer program product of claim 12, wherein the second set of instruction codes generates a derived modification detection code from a presented modification detection code, for each statement, and compares the derived modification detection code to the presented modification detection code.

14. The computer program product of claim 13, wherein the integrity of the modification detection code is validated if the derived modification detection code matches the presented modification detection code;
wherein the integrity of the modification detection code is not validated if the derived modification detection code does not match the presented modification detection code; and
wherein the integrity of the modification detection code is not validated if no modification detection code exists.

15. The computer program product of claim 12, further comprising:
an unload function for unloading data to a database;
an alter object function for modifying the statements with new attributes to create altered statements; and
a create function for generating a revised modification detection code for each statement and for comparing the revised modification detection code to the derived modification detection code, to validate the integrity of the derived modification detection code, for determining an authority for execution of the statement.

16. A system for selectively executing statements with a surrogate authority, comprising:
means for generating a modification detection code for each statement;
means for checking the integrity of the modification detection code;
if the integrity of the modification detection code is validated, the checking means executes the statement with the surrogate authority; and
if the integrity of the integrity of the modification detection code is not validated, the checking means executes the statement with a lesser authority.

17. The system of claim 16, further comprising a DDL generation function that defines a file that contains the statements.

18. The system of claim 17, wherein the checking means generates a derived modification detection code from a presented modification detection code, for each statement, and compares the derived modification detection code to the presented modification detection code.

19. The system of claim 18, wherein the integrity of the modification detection code is validated if the derived modification detection code matches the presented modification detection code;
wherein the integrity of the modification detection code is not validated if the derived modification detection code does not match the presented modification detection code; and
wherein the integrity of the modification detection code is not validated if no modification detection code exists.

20. The system of claim 17, further comprising:
an unload function for unloading data to a database;
an alter object function for modifying the statements with new attributes to create altered statements; and
a create function for generating a revised modification detection code for each statement and for comparing the revised modification detection code to the derived modification detection code, to validate the integrity of the derived modification detection code, for determining an authority for execution of the statement.
